(19) United States
(12) Patent Application Publication
(10) Pub. No.: US 2018/0268346 A1
(43) Pub. Date: Sep. 20, 2018

(54) METHOD AND SYSTEM FOR TRACKING AND MANAGING LOCATIONS OF WORKERS IN A PARK

(71) Applicant: Panasonic Intellectual Property Management Co., Ltd., Osaka (JP)

(72) Inventors: John CRONIN, Bonita Springs, FL (US); Joseph BODKIN, South Burlington, VT (US); Masayuki IINO, Arlington, VA (US)

(21) Appl. No.: 15/463,598

(22) Filed: Mar. 20, 2017

(51) Int. Cl. G06Q 10/06; H04L 29/08; H04W 4/02

(52) U.S. Cl. CPC G06Q 10/063116; H04W 4/02; H04L 67/18; G06Q 10/063114

(57) ABSTRACT

In a method for tracking workers in a park, work areas for the workers are defined, respectively, which include a first work area defined for a first worker. The defined work areas are transmitted to worker devices, respectively, which include a first worker device provided for the first worker. When it is determined that the location of the first worker device is outside of the first work area, the first user is prompted to input or select a report, and when the report is acquired by the first worker device, the report is wirelessly transmitted from the first worker device to the management server. An action in response to the transmitted report is determined, and assistance information corresponding to the determined action is wirelessly transmitted from the management server to one or more of the worker devices.

### TECHNICAL FIELD

The disclosure relates to a method and a system for tracking and managing locations of workers and/or employees in a park, such as an amusement park.

### BACKGROUND

In an amusement park or other parks, workers and/or employees conduct multiple tasks and interact with customers based on designed work flow patterns and in designated work areas. The tasks may include cleaning, customer assistance and/or security checks. While the work areas are pre-determined or pre-defined for the workers, respectively, abnormal situations may require one or more workers to move out the designated work area. Currently, there is no available system to systematically and flexibly manage and control workers/employees and their work areas.

### SUMMARY

According to another aspect of the present disclosure, in the method for tracking workers in an amusement park, work areas for the workers are defined, respectively, and the defined work areas are stored in a work area database of a management server. The work areas include a first work area defined for a first worker. The defined work areas are transmitted to worker devices, respectively. The worker devices include a first worker device provided for the first worker. It is determined whether or not the location of the first worker device is within the first work area defined for the first worker. When it is determined that the location of the first worker device is outside the first work area, the first user is prompted to input or select a report, and when the report is acquired by the first worker device, the report is wirelessly transmitted from the first worker device to the management server. An action in response to the transmitted report is determined, and assistance information corresponding to the determined action is wirelessly transmitted from the management server to one or more of the worker devices.

According to another aspect of the present disclosure, in the method for tracking workers in an amusement park, work areas for the workers are determined, respectively. The work areas include a first work area defined for a first worker. A communication is wirelessly received by a server from a first worker device assigned to and carried by the first worker. Based on the communication, a second worker located adjacent to the first work area is found, a second work area for the second worker is revised and assistance information is determined. The revised second work area and the assistance information are wirelessly transmitted to a second worker device assigned to and carried by the second worker.

According to yet another aspect of the present disclosure, a work area management system includes a management server including a management-side computer and a management-side non-transitory storage medium storing a management program, and a plurality of worker devices, including a first worker device assigned to a first worker, the first worker device including a device-side computer and a device-side non-transitory storage medium storing a device program. The management program, when executed by the management-side computer, causes the management server to perform operations including: defining a plurality of work areas for the plurality of workers, respectively; storing the defined plurality of work areas in the management-side non-transitory storage medium, the plurality of work areas including a first work area defined for the first worker; and transmitting the defined plurality of work areas to the plurality of worker devices, respectively. The device program, when executed by the device-side computer, causes the first worker device to perform operations including: when it is determined, by the first worker device or the management server, that the location of the first worker device is outside of the first work area, prompting the first user to input or select a report, and when the report is acquired by the first worker device, wirelessly transmitting the report to the management server. The management program, when executed by the management-side computer, further causes the management server to perform operations including: receiving the report from the first worker device; determining an action in response to the report; and wirelessly transmitting assistance information corresponding to the determined action to one or more of the plurality of worker devices.

According to another aspect of the present disclosure, in the method for tracking at least one worker in a park, at least one worker's work area is defined through an interface of a first computer system. The defined at least one worker's work area is stored in a work area database of the first computer system. At least one worker's current location is tracked by using a GPS device of a second computer system carried by the at least one worker. The tracked at least one worker's current location is stored in a memory of the second computer system. The at least one worker's current location is wirelessly transmitted to the first computer system. The transmitted at least one worker's current location is displayed, on a display of the first computer system, on a map generated and displayed by the first computer system. By using the first computer system, the transmitted at least one worker's current location and a corresponding work area for the at least one worker stored in the work area database are compared. A notification is wirelessly transmitted, by the first computer system, to the second computer system, when the at least one worker's current location is outside the corresponding work area defined for the at least one worker. At least one response of the at least one worker to the transmitted notification is acquired, by the second computer system. The acquired at least one response is stored in the memory of the second computer system. The at least one response is wirelessly transmitted, by the second computer system, to the first computer system.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only.

FIG. 1 is an exemplary configuration illustrating a system for managing workers according to embodiments of the present disclosure.

FIG. 2 is an exemplary configuration illustrating a management-side storage according to embodiments of the present disclosure.

FIGS. 3A and 3B are exemplary maps illustrating work areas according to embodiments of the present disclosure.

FIG. 4 is an exemplary flow chart illustrating operations for managing workers according to embodiments of the present disclosure.

FIG. 5 is an exemplary flow chart illustrating operations for managing workers according to embodiments of the present disclosure.

FIG. 6 is an exemplary screen view of a worker's device according to embodiments of the present disclosure.

FIG. 7 is an exemplary flow chart illustrating operations for managing workers according to embodiments of the present disclosure.

FIGS. 8A-8D show an exemplary operation for redefining work area according to embodiments of the present disclosure.

FIG. 9 is an exemplary flow chart illustrating operations for managing workers according to embodiments of the present disclosure.

FIGS. 10A-10D show an exemplary operation for redefining work area according to embodiments of the present disclosure.

FIG. 11 is an exemplary flow chart illustrating operations for managing workers according to embodiments of the present disclosure.

FIG. 12 shows an exemplary operation for defining a route according to embodiments of the present disclosure.

FIG. 13 is an exemplary flow chart illustrating operations for managing workers according to embodiments of the present disclosure.

### DETAILED DESCRIPTION

It is to be understood that the following disclosure provides many different embodiments, or examples, for implementing different features of the present subject matter. Specific embodiments or examples of components and arrangements are described below to simplify the present disclosure. These are, of course, merely examples and are not intended to be limiting.

In view of the foregoing, the present disclosure, through one or more of its various aspects, embodiments and/or specific features or sub-components, is thus intended to bring out one or more of the advantages as specifically noted below.

One of the purposes of the present disclosure is to efficiently manage the work space of workers (employees, staffs) in a park, such as an amusement park or a theme park. As one broad aspect of the present disclosure, the management system includes a tracking device (worker device) carried or worn by each worker to track where the workers are in the park (i.e., the location of the workers within the park). A management system is used to define working areas (working spaces) and to ensure the workers stay in their designated area. The system can notify the management via the management server that one or more workers have moved outside of the defined areas so as to more carefully manage the workers. By utilizing heat or travel maps, it is possible to manage workers so as not to overpopulate in a given work area, thereby reducing manpower in other areas, so that the workers remain properly distributed throughout the park, and customer satisfaction is maintained at a high level.

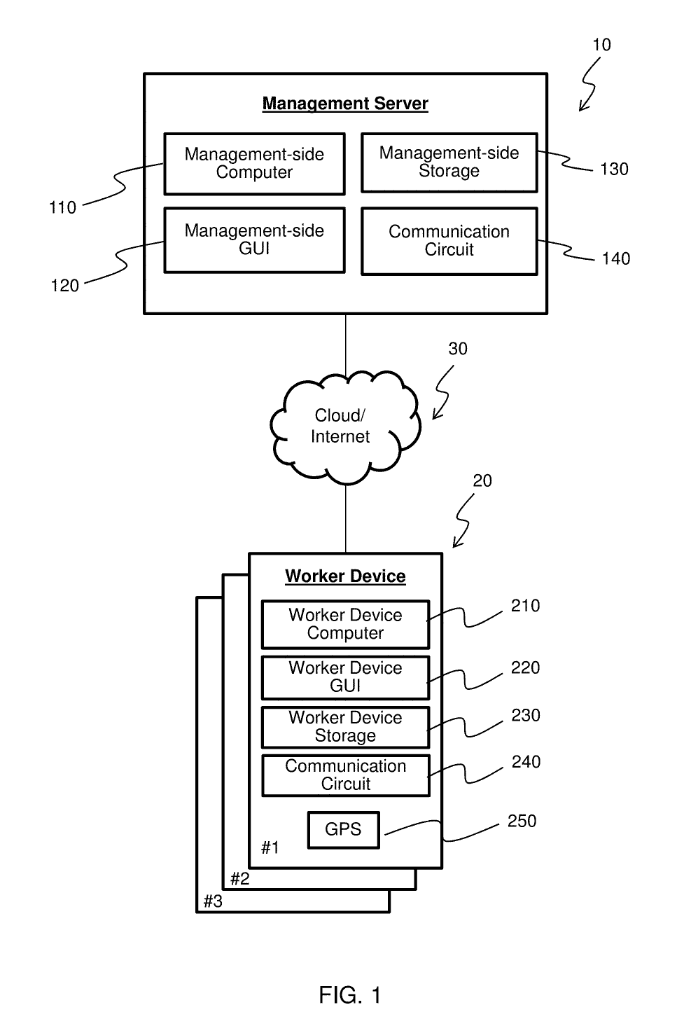

FIG. 1 is an exemplary configuration illustrating a system for managing workers according to embodiments of the present disclosure. The system includes a management server 10 and one or more worker devices 20 wirelessly connected by a network 30. The network 30 may be the internet, a local area network, a cloud or any other suitable wireless network.

In some embodiments, the management server 10 includes a management-side computer 110, a management-side graphical user interface (GUI) 120, a management-side storage 130 and a communication circuit 140.

The management-side computer 110 includes a CPU (central processing unit) and other electrical circuity. The management-side storage 130 includes one or more memories such as a ROM, a RAM, an EEPROM, a hard disk drive and/or a solid state memory. The memories may be a built-in type memory or a removable memory. The management-side storage 130 includes a management control program (software) 132, which is executable by the CPU of the management-side computer 110, and when executed, controls operations of the management server 10. The software may further include network tracking software, network schedule software, network alert software and/or communication controls software.

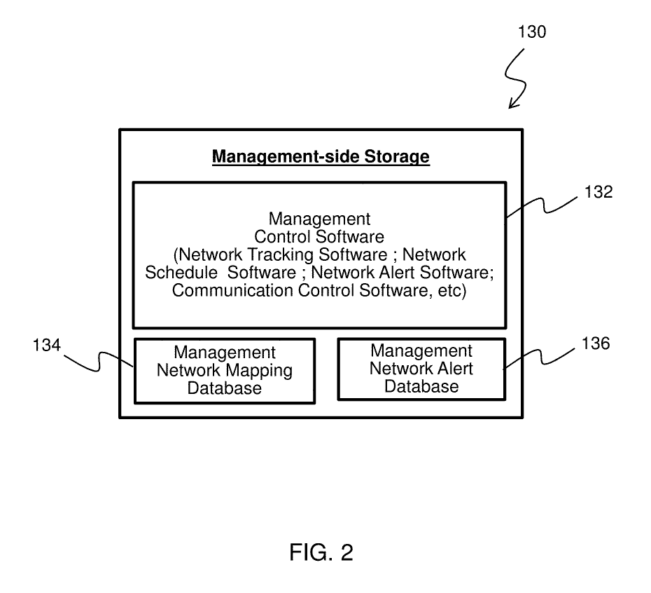

The management-side storage 130 may further include various databases such as a management network mapping database 134 and/or a management network alert database 136, as shown in FIG. 2.

The management-side GUI 120 includes an input device, such as a keyboard and a mouse, a display, such as an LCD monitor, and/or a sound system, such as a speaker and a microphone. The communication circuit 140 makes a wireless and/or a wired communication with outside devices possible. The management-side GUI 120 and the communication circuit 140 are controlled by the management control program 132.

The worker device 20 is a handheld mobile device, such as a cell phone, a smart phone, a PDA, a tablet computer or a laptop computer. The worker device 20 includes a device-side computer 210, a device-side GUI 220, a device-side storage 230 and a communication circuit 240.

The device-side computer 210 includes a CPU and other electrical circuity. The device-side storage 230 includes one or more memories such as a ROM, a RAM, an EEPROM, a hard disk drive and/or a solid state memory. The memories may be a built-in type memory or a removable memory. The device-side storage 230 includes a device control program (software), which is executable by the CPU of the device-side computer 210, and when executed, controls operations of the worker device 20.

The device-side GUI 220 includes an input device, such as a keyboard and a mouse, a display, such as an LCD monitor, and/or a sound system, such as a speaker and a microphone. In some embodiments, a touch sensitive panel is employed as a GUI. The communication circuit 240 makes a wireless and/or a wired communication with the management server 10 possible. The device-side GUI 220 and the communication circuit 240 are controlled by the device control program.

The worker device 20 further includes a GPS location system 250. The GPS location system can receive GPS signals and then determines/obtains the current location/position of the worker device 20.

In the park, a plurality of workers work. Each worker is provided with a work area assigned to the given worker. The management server may automatically or with assistance of a manager define the work area for each of the plurality of workers.

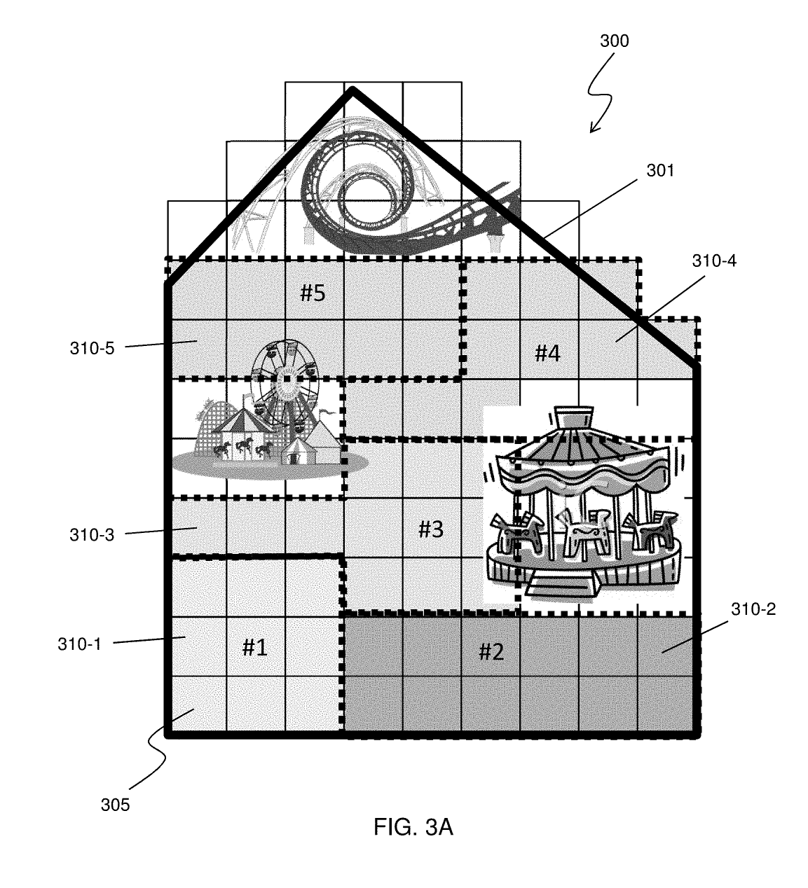

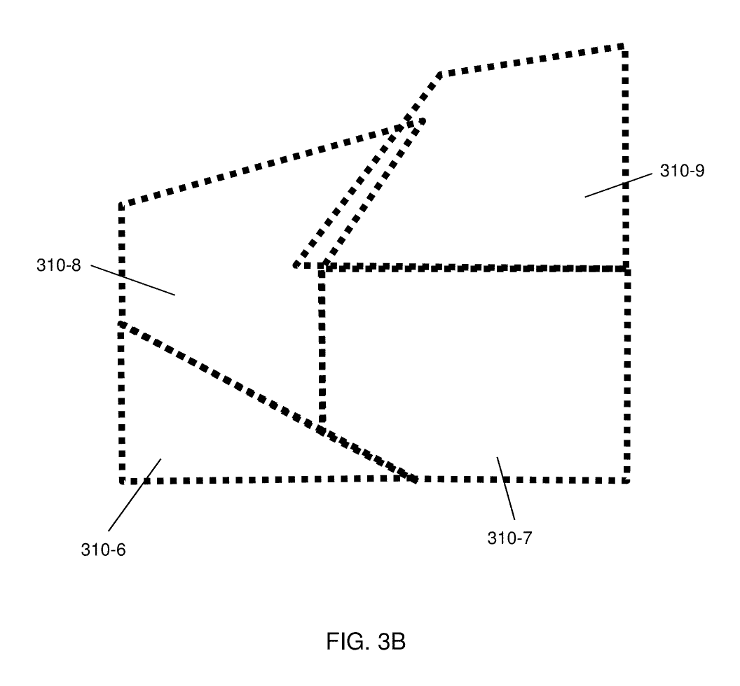

FIG. 3A is an exemplary map illustrating work areas according to embodiments of the present disclosure. In this embodiment, for example, five workers are working in a park 300 within the park boundary 301.

In some embodiments, the park area 300 is divided into small blocks 305 each having the substantially same size area. The work areas 310-1 to 310-5 are defined to worker #1 to worker #5, respectively. Each work area includes about 9 to 10 blocks 305 as shown in FIG. 3A. The shape of the work areas may be rectangular or polygonal. When a block includes the park boundary, such a block may or may not be assigned to a work area. Two or more work areas may partially overlap with each other.

FIG. 3B shows another exemplary map illustrating work areas according to some embodiments of the present disclosure. In FIG. 3B, the work areas 301-6 to 310-9 are defined by a polygon with three or more vertexes. Further, in some embodiments, as shown by the work areas 310-8 and 310-9, two or more work areas may partially overlap with each other.

The workers are generally required to work within the assigned work area and are not supposed to move out the assigned work area. However, for variety reasons, workers may often move out their designated areas.

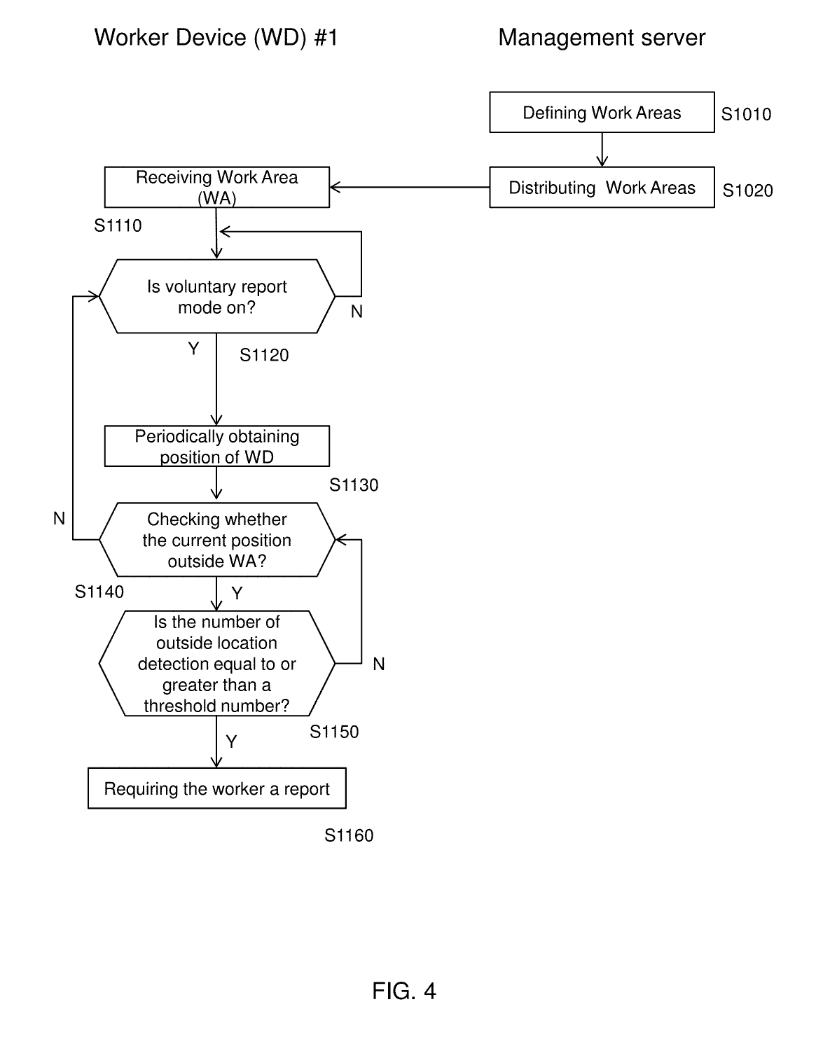

FIG. 4 is an exemplary flow chart illustrating operations for managing workers according to embodiments of the present disclosure. This flow chart describes how to monitor the location of one of the workers carrying a worker device 20 and operations performed when the worker moves out the assigned work area.

In S1010, the work areas for the workers are defined by the management server 10 as set forth above with respect to FIGS. 3A and 3B. The defined work areas are stored in the management network mapping data base 134 of the management-side storage 130.

In S1020, the management server 10 distributes the defined work areas to respective worker devices 20 by using the communication circuit 140. This communication may be wireless, wired or via a memory device, such as a memory card or a USB device. In S1110, the worker device 20 for the worker #1, for example, receives the assigned work area via the communication circuit 240, and the assigned work area is stored in the device storage 230.

The worker is required to turn on a voluntary report mode on the worker device during his/her work time, at S1120. In FIG. 4, in the voluntary report mode, the worker device 10 periodically monitors the location of the worker, and periodically checks whether the worker is within the assigned work area or not. A non-voluntary report mode may be selected when the worker is off-duty, for example, for a break or a lunch. When the voluntary report mode is not selected (i.e., the non-voluntary report mode is selected), the worker device waits for an operation that the voluntary report mode is turned on.

When the voluntary report mode is turned on (“Y” at S1120), the worker device periodically obtains the location of the worker device, i.e., the location of the worker #1 (81130). The location of the worker device 20 can be obtained by using a GPS system 250, and may be stored in the device-side storage 230 as a location history.

In S1140, the worker device 20 periodically checks whether the worker is within the assigned work area or not, by comparing the obtained location and the assigned work area stored in the device storage 230. The frequency of the location check may be every 30 seconds to every 5 minutes. In other embodiments, the work area is not distributed to the worker device, and in such a case, the worker device 20 sends an inquiry with the location information to the management server so that the management server can determine whether the worker is within the assigned work area or not.

When it is determined that the worker is within the assigned work area (“N” at S1140), the process returns to S1120 or S1130. The worker device 20 can monitor the number of times that the worker is determined being outside the assigned work area and/or the time duration that the worker is outside the assigned work area.

When it is determined that the worker is outside the assigned work area (“Y” at S1140), the worker device determines whether the number of times that the worker is determined being outside the assigned work area exceeds a threshold number (S1150). The threshold number may be one (1) or more. When the threshold number is set, for example, at two (2) or more, an accidental moving out may be omitted and thus the reporting burden for the worker can be reduced.

In other embodiments, the worker device determines whether the time duration that the worker is outside the assigned work area exceeds a threshold time duration. The threshold time duration may be, for example, 1 minutes to 10 minutes.

If at S1150, the number of times or the time duration exceeds the threshold (“Y” at S1150), the worker device 20 requests the worker #1 to report the reasons for being outside the assigned work area to the management server 10 (S1160).

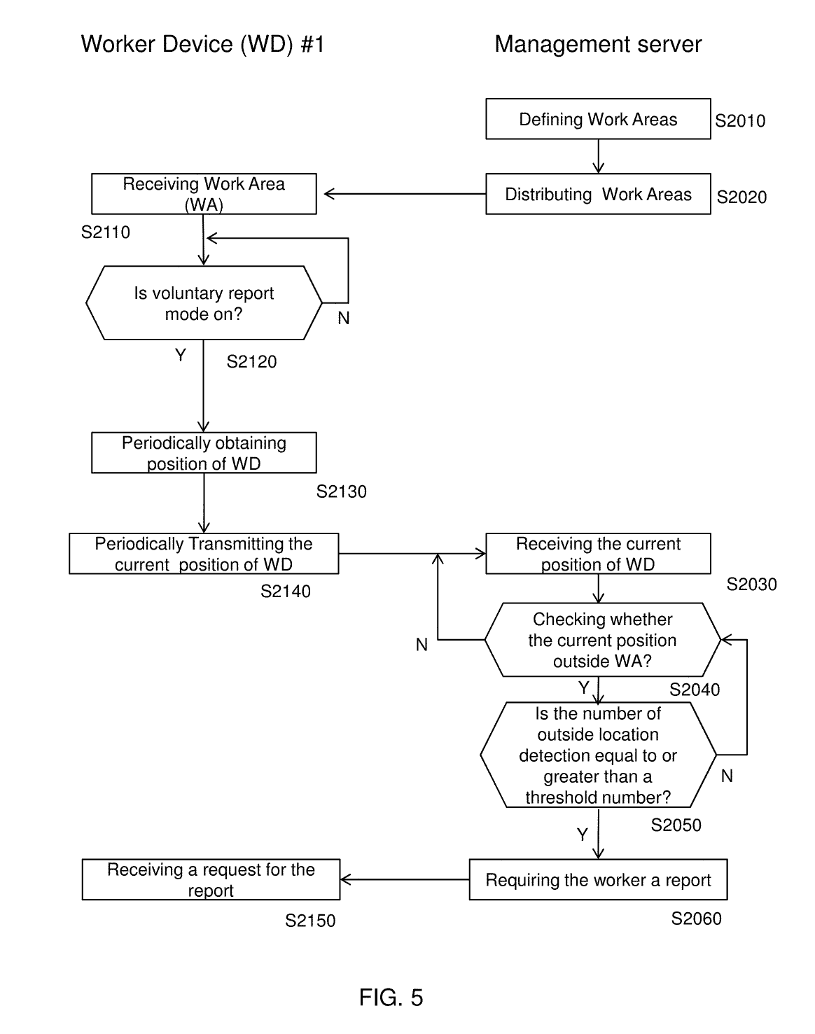

FIG. 5 is an exemplary flow chart illustrating operations for managing workers according to some embodiments of the present disclosure. In FIG. 5, unlike FIG. 4, the worker device 10 periodically monitors the location of the worker, and periodically sends the location to the management server so that the management server determines whether the worker is within the assigned work area or not.

The operations S2010, S2010, S2110, S2120 and S2130 of FIG. 5 are substantially the same as the operations S1010, S1010, S1110, S1120 and S1130 of FIG. 4.

In S2140, the worker device periodically transmits the current location of the worker device to the management server 20, and in S2030, the management server receives the location of the worker device. Of course, the management server receives location information from the worker devices in the voluntary report mode. In some embodiments, the management server receives location information from the worker devices at different timings. The received location information may be stored in the management-side storage 130 as a location history.

In S2040, the management server 10 periodically checks whether the worker(s) is within the assigned work area(s) or not, by comparing the received location and the assigned work area stored in the management-side storage 130. The frequency of the location check may be, for example, every 30 seconds to every 5 minutes.

The locations of one or more workers are displayed on a map together with work area boundaries on a display device, such as an LCD monitor. The map may be a heat map or a travel map.

When it is determined that the worker is within the assigned work area (“N” at S2040), the process returns to S2030. The management server 10 can monitor the number of times that the worker is determined being outside the assigned work area and/or the time duration that the worker is outside the assigned work area.

When it is determined that the worker is outside the assigned work area (“Y” at S2040), the management server determines whether the number of times that the worker is determined being outside the assigned work area exceeds a threshold number (S2050). The threshold number may be one (1) or more. When the threshold number is set, for example, at two (2) or more, an accidental moving out of the assigned work area may be omitted and thus reporting burden for the worker may be reduced.

In other embodiments, the management server determines whether the time duration that the worker is outside the assigned work area exceeds a threshold time duration. The threshold time duration may be, for example, 1 minutes to 10 minutes.

If at S2050, the number of times or the time duration exceeds the threshold (“Y” at S2050), the management server 10 sends a request to the worker device to report the reasons that the worker is outside the assigned work area to the management server 10 (S2060), and the worker device 10 receives such a request at S2150.

In either of the processes of FIG. 4 or FIG. 5, when it is determined that the worker (#1) is outside of the assigned work area, the worker is requested to report the reason why the worker is outside of the assigned work area.

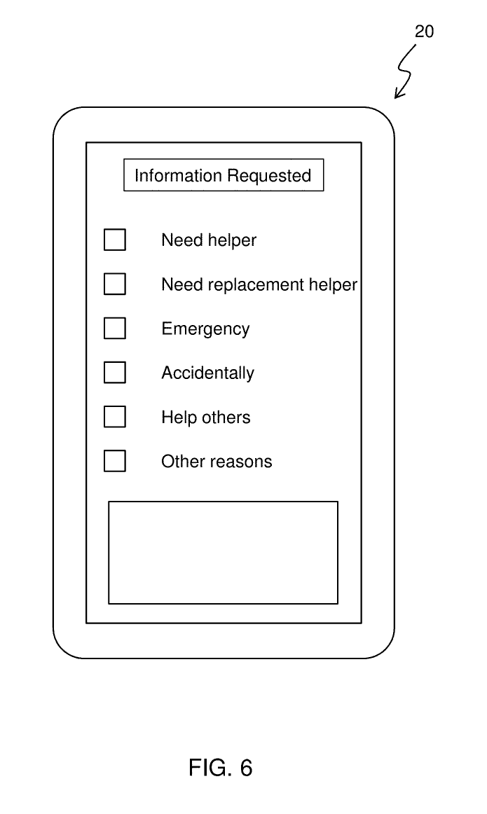

FIG. 6 is an exemplary screen view of a worker's device according to embodiments of the present disclosure.

In some embodiments, the worker device 20 requests the worker to select one of the reasons as listed on the screen. The reasons for being outside the assigned work area may include, but not limited to, “Need helper,” “Need replacement,” “Emergency,” “Accidentally,” “Help others,” and/or “Other reasons.” When the reason is selected, such a selection may be stored in the worker device 20.

When “Accidentally” is selected, the management server continues monitoring the worker, or may request further information by the worker. If one of the other reasons is selected by the worker, the one or more following operations are performed. In the following embodiments, one or more examples, operations and/or configurations of one embodiment may be applied to another embodiment.

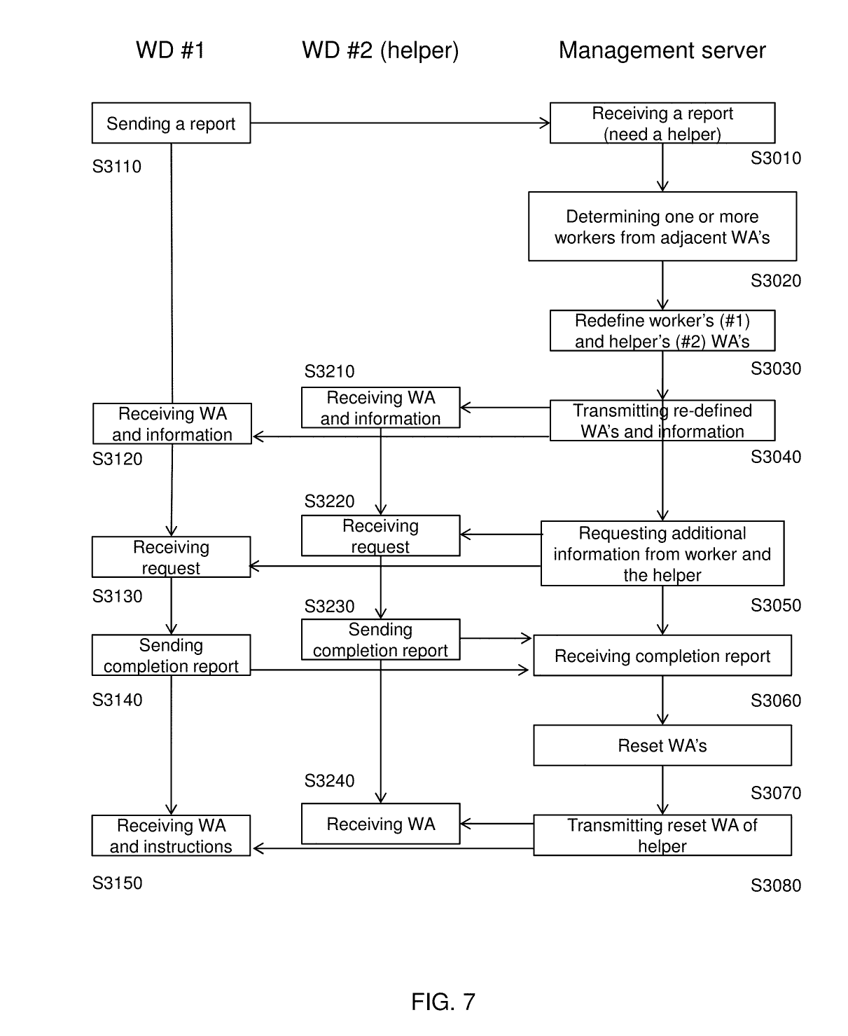

FIG. 7 shows an exemplary flow chart illustrating operations when “Need helper” is selected. The worker selects “Need helper” when he/she needs help from other workers. For example, the worker #1 finds that worker #3 is in trouble in work area 310-3, and the worker goes into the work area 310-3 to help the worker #3. When the worker #1 finds that an additional helper is necessary, the worker #1 selects “Need helper” to request the management server to send one or more additional helpers.

By selecting “Need helper,” the worker device #1 sends a report to the management server (S3110) and the management server receives the request (S3010). The request may include additional information, for example, the current location of the worker #1. The received request (response) is stored in a management network alert database 136 of the management-side storage 130.

The management server determines one or more workers working in the adjacent work area(s) or the work area(s) near the location of worker #1, as one or more helpers (S3020). In one example, the management server determines worker #2 as the helper. Then, the management server redefines the work areas for the worker #1 and the worker #2 (S3030) so that even though the workers #1 and #2 work outside the originally assigned work areas, the worker devices and/or the management server do not alert the workers any more.

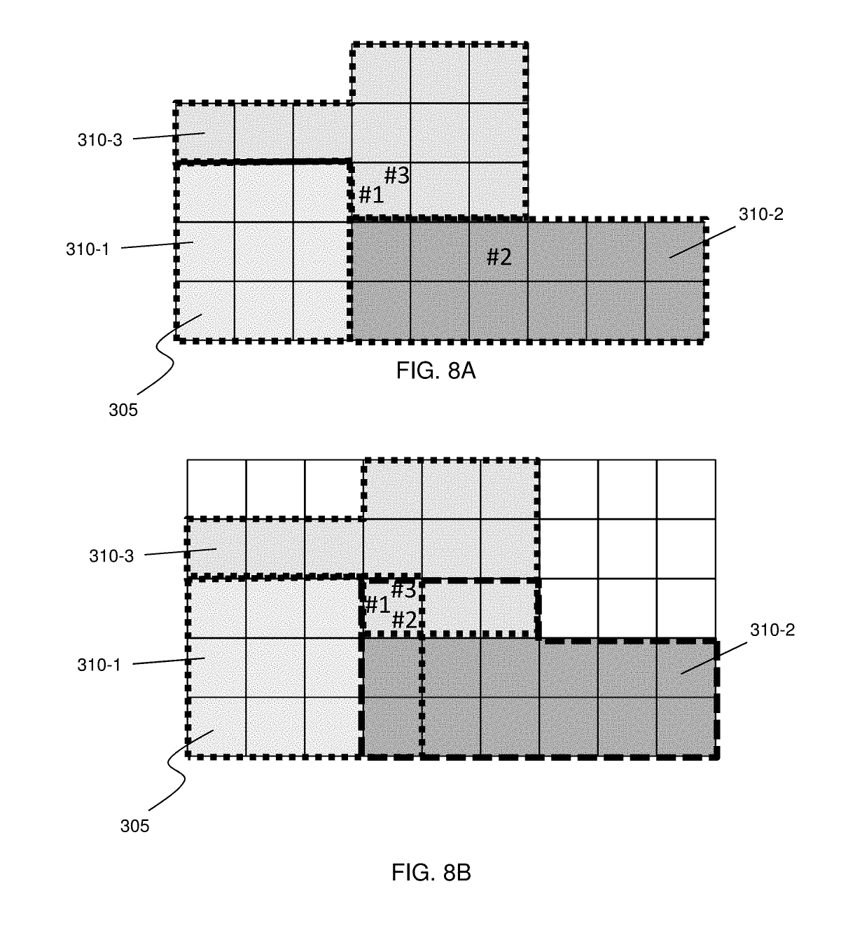

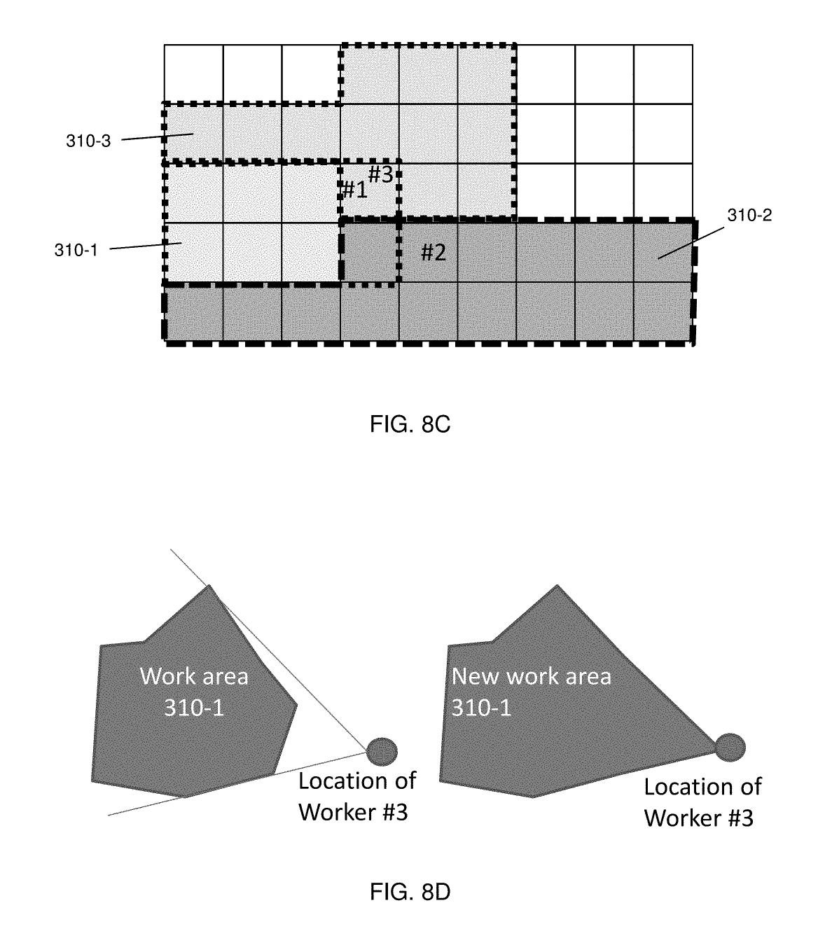

FIGS. 8A-8D show an exemplary operation for redefining work area according to embodiments of the present disclosure. In FIG. 8A, the worker #1 moves outside of the assigned work area 310-1 to help the worker #3. After redefining the work areas, as shown in FIG. 8B, the work area 310-1 is expanded and the work area 310-2 for the helper worker #2 is also expanded, to include the location of the workers #1 and #2, based on the location information of the worker #1. In other embodiments, the work area 310-2 may be redefined to at least partially cover the work area 310-1, and not to include the current location of the worker #1, as shown in FIG. 8C.

In FIG. 8D, when the work areas are defined by polygons, the tangents between the work area 310-1 and the location of worker #3 (e.g., 2 lines) are defined, thereby making a new closed area. The work area 310-1 is expanded to fulfill the new closed area. In this process, it is possible to minimize the new area assigned to worker #1.

The redefined work areas are transmitted to the worker devices of the workers #1 and #2, respectively, together with additional information (S3030), and the worker devices of the workers #1 and #2 receive the redefined work areas and the additional information, respectively (S3120, S3210). The additional information to the worker #1 may include the identification of the helper and any suitable instructions to handle the issue, and the additional information to the worker #2 may include instructions to help the worker #1, the location of worker #1 and/or any suitable instructions to handle the issue. After a predetermined time, the management server may transmit a request for additional information to the worker devices to request the workers #1 and #2 current situation (S3050), and the worker devices receive such a request, respectively (S3130, S3220).

When the workers #1 and #2 resolve the issue, at least one of the workers #1 and #2 sends a completion report to the management server (S3140, S3230), and the management server receives the completion report (S3060). When the management server receives at least one of the completion reports, the management server resets the redefined work areas 310-1 and 310-2 to the original work areas (S3070).

Then, the reset work areas are transmitted from the management server to the worker devices, respectively (S3080), and the worker devices receive the reset work areas, respectively (S3150, S3240). In some embodiments, the reset work area is transmitted, and in other embodiments, an instruction to reset the work area to the original work area is transmitted.

In certain embodiments, the management server redefines new work areas for the workers #1 and #2 depending on the result of the worker #3's issue. For example, the new work areas may be redefined for the workers #1 and #2 to cover the work area 310-3 of the worker #3, if worker #3 cannot continue working.

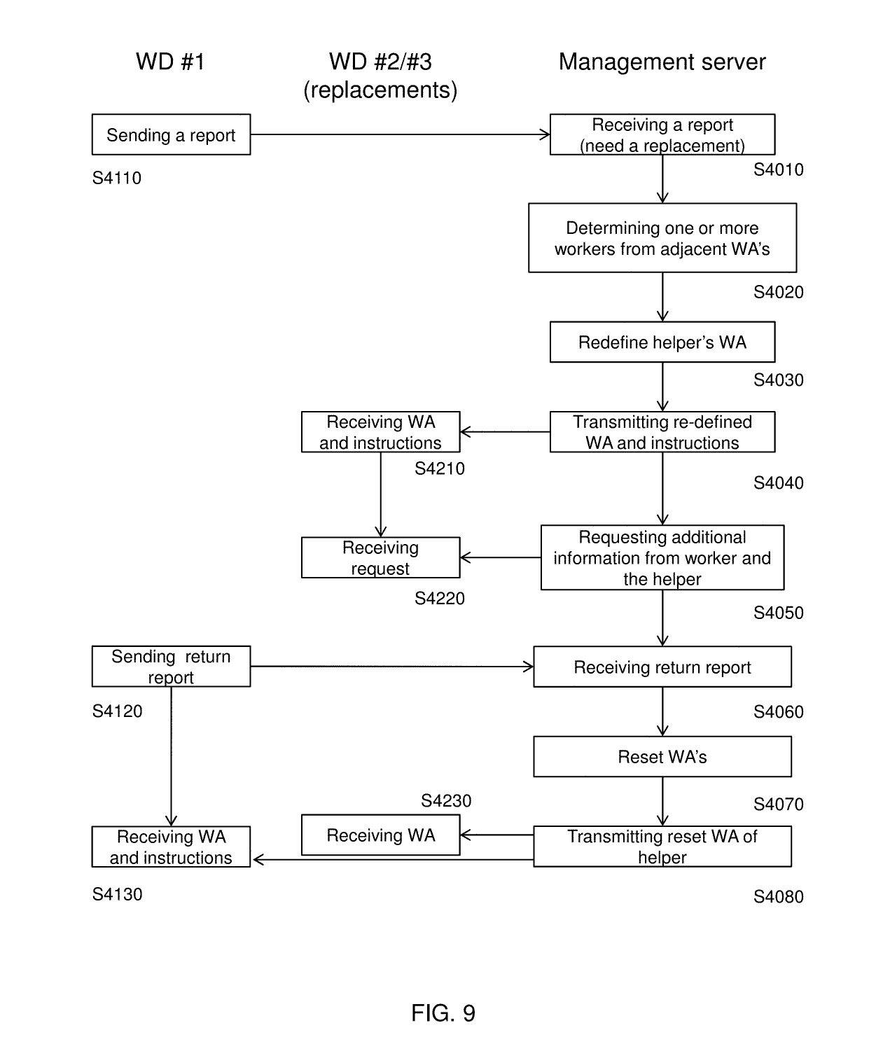

FIG. 9 shows an exemplary flow chart illustrating operations when “Need replacement” is selected. The worker selects “Need replacement” when he/she needs a replacement worker to cover the work area for the requesting worker. For example, the worker #1 feels very bad and has to go a medical center leaving the job, and the worker #1 moves out of the assigned work area 310-1. When the worker #1 realizes that a replacement worker is necessary, the worker #1 selects “Need replacement” to request the management server to send one or more replacement workers.

By selecting “Need replacement,” the worker device #1 sends a report to the management server (S4110) and the management server receives the request (S4010). The request may include additional information, for example, the current location of the worker #1.

The management server determines one or more workers working in the adjacent work area(s) or the work area(s) near the location of worker #1, as one or more replacements (S4020). In one example, the management server determines workers #2 and #3 as the replacements. Then, the management server redefines the work areas for the workers #2 and #3 (310-2 and 310-3) (S4030) to cover the work area 310-1 originally assigned to the worker #1.

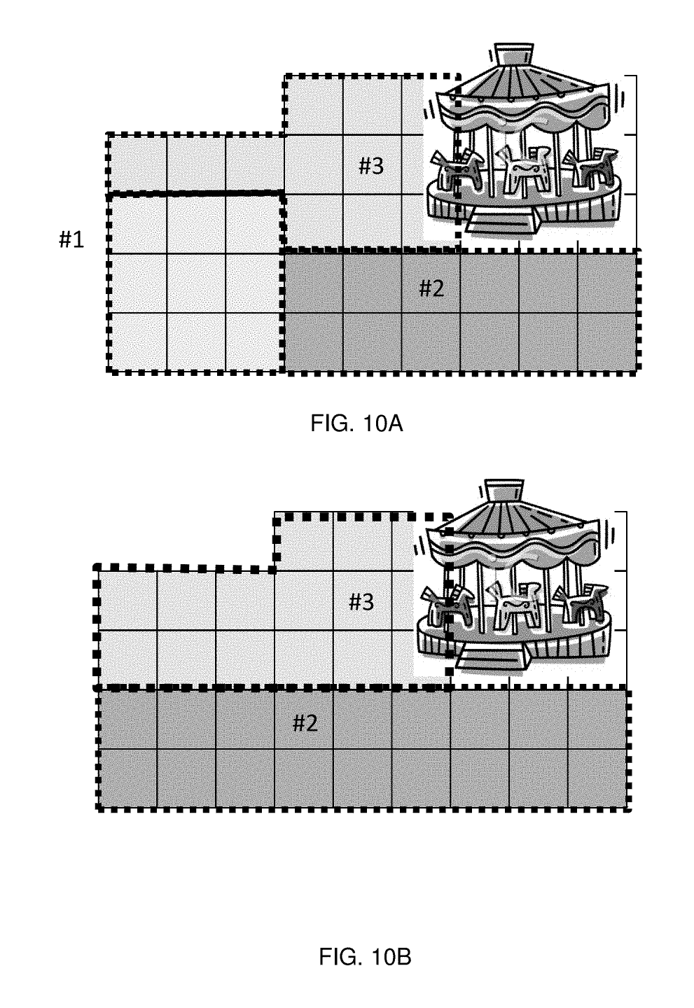

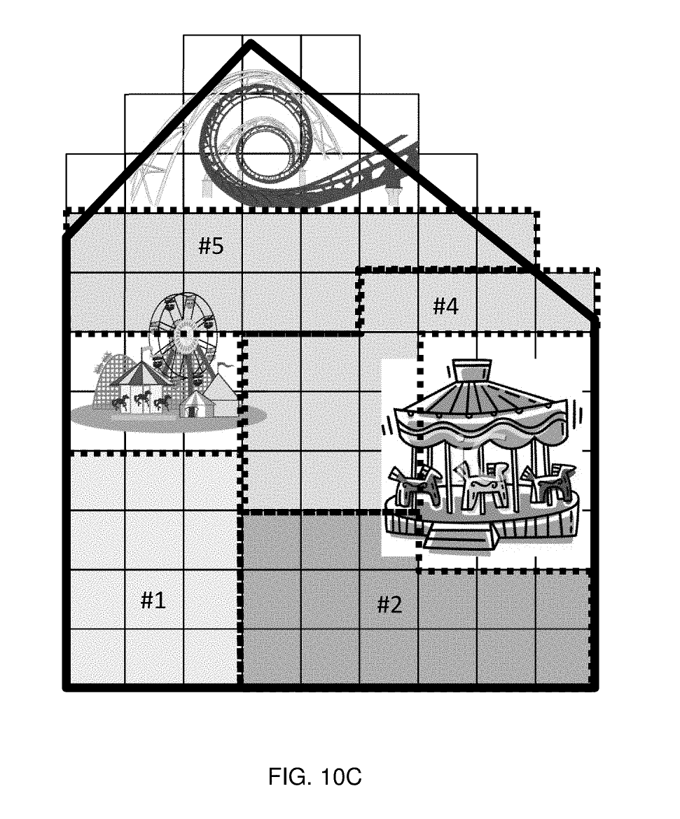

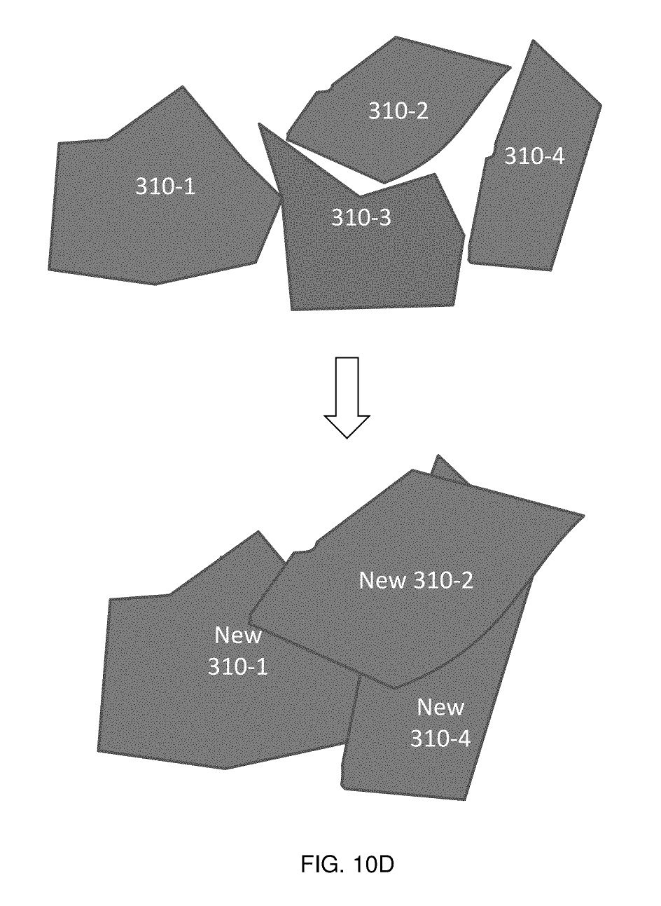

FIGS. 10A-10D show an exemplary operation for redefining work area according to embodiments of the present disclosure. In FIG. 10A, the worker #1 moves outside of the assigned work area 310-1. After redefining the work areas, as shown in FIG. 10B, the work area 310-1 is covered by the work area 310-2 for the worker #2 and the work area 310-3 for the worker #3. Further, the work area 310-1 is made inactive.

FIG. 10C shows another example of redefining the work areas. In FIG. 10C, the worker 3# leaves the job and workers #1, #2, #4 and #5 covers the work areas. When redefining the work areas, the management server redefines the work areas such that areas of the new work areas are substantially equal to each other (e.g., the difference is less than 10%).

In FIG. 10D, when the work areas are defined by polygons, the work areas 310-1, 310-2 and 310-4 are expanded (scaled) to cover the missing work area 310-3. The scaling may be equal in all directions (horizontal and vertical) or may be weighted depending on the directions.

The redefined work areas are transmitted to the worker devices of the workers #2 and #3, respectively, together with additional information (S4030), and the worker devices of the workers #1 and #2 receive the redefined work areas and the additional information, respectively (S4210). The additional information to the workers #2 and #3 may include a message notifying that a new work area is defined, a reason of redefining and/or a time duration for working in the new work area. After a predetermined time, the management server may transmit a request for additional information to the worker devices to request the workers #2 and #3 current situation (S4050), and the worker devices receives such a request, respectively (S4220).

In some embodiments, the worker #1 may return to the job. In such a case, the worker device of worker #1 sends a return report to the management server (S4120), and the management server receives the return report (S4060). When the management server receives the return report, the management server resets the redefined work areas 310-2 and 310-3 to the original work areas (S4070), and makes the work area 310-1 active again.

Then, the reset work areas and a reactivation instruction are transmitted from the management server to the worker devices, respectively (S4080), and the worker devices receive the reset work areas and the instruction, respectively (S4130, S4130). In some embodiments, the reset work area is transmitted, and in other embodiments, an instruction to reset the work area to the original work area is transmitted.

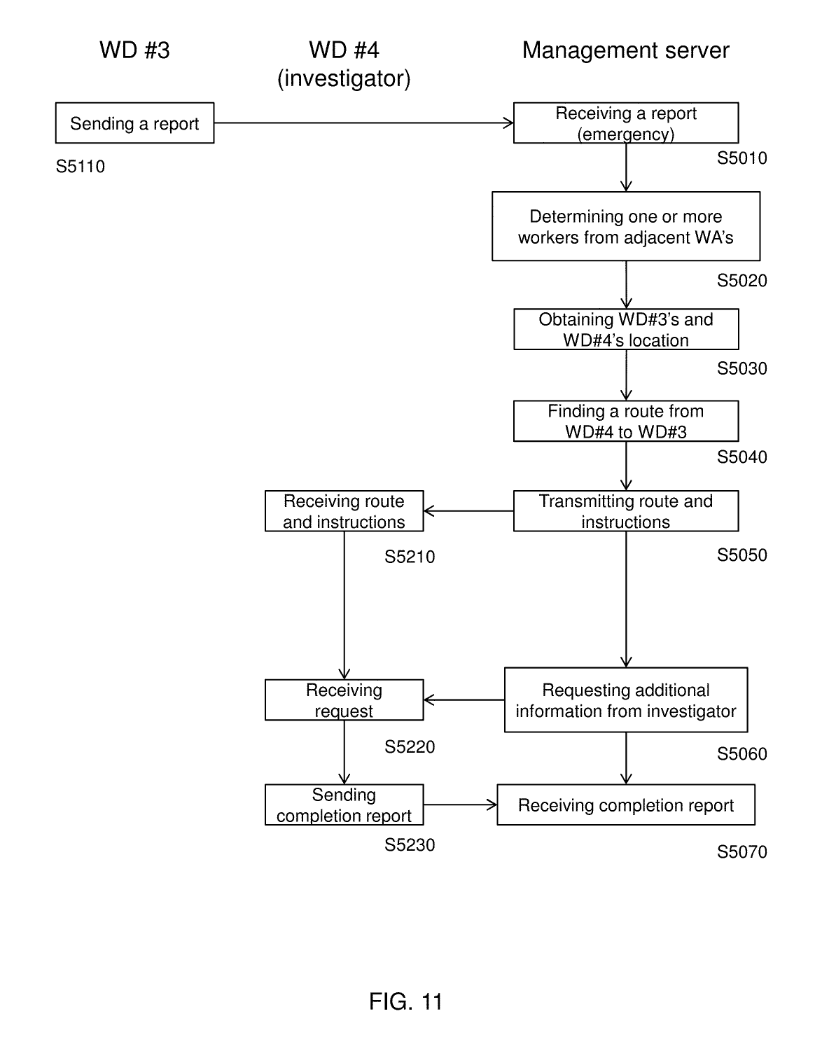

FIG. 11 is an exemplary flow chart illustrating operations for managing workers according to other embodiments of the present disclosure. In this scenario, a worker (e.g., #3) does not necessarily move outside the assigned work area.

The worker #3 wirelessly sends a report to the management server (S5110), for example, when the worker #3 encounters an emergency situation that the worker #3 cannot handle or resolve. When the management server receives the report (S5010), the management server determines one or more workers working in the adjacent work area(s) or the work area(s) near the location of worker #3, as one or more investigators (S5020). In one example, the management server determines worker #4 as the investigator. In some embodiments, the management server may find one or more investigators when the management server detects an abnormal situation of the worker #3 (e.g., the worker device #3 remains the same location for a longer period of time than a threshold period).

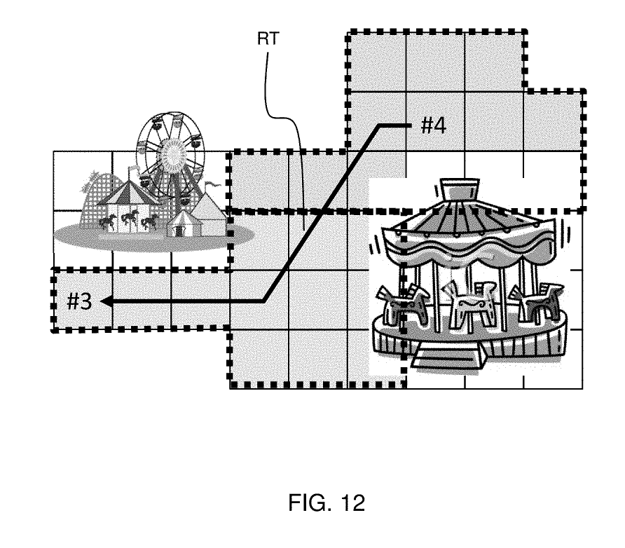

In some embodiments, the management server may obtain the locations of the worker device #3 and the worker device #4 (S5030). Then, the management server determines a route (e.g., a shortest route) from the location of the worker device #4 to the worker device #3 (S5040), as shown in FIG. 12. The management server wirelessly transmits the determined route to the worker device #4 of the investigator (S5050) together with investigation instructions, and the worker device #4 receives the route and the instructions (S5210). The investigation instructions may include the information with respect to the worker #3, the time of the last communication from worker #3, or the like.

The management server may also redefine the work area for the worker #4 to include the route to the worker #3 and/or the work area for the worker #3, and transmits the redefined work area for the worker #4 to the worker device #4.

After a predetermined time, the management server may transmit a request for additional information to the worker device #4 to request the worker #4 current situation (S5060), and the worker device #4 receive such a request (S5220).

When the worker #4 resolves the issue, the worker #4 sends a completion report to the management server (S5230), and the management server receives the completion report (S5070). When the management server receives the completion report, the management server may reset the redefined work area for the worker #4 to the original work area.

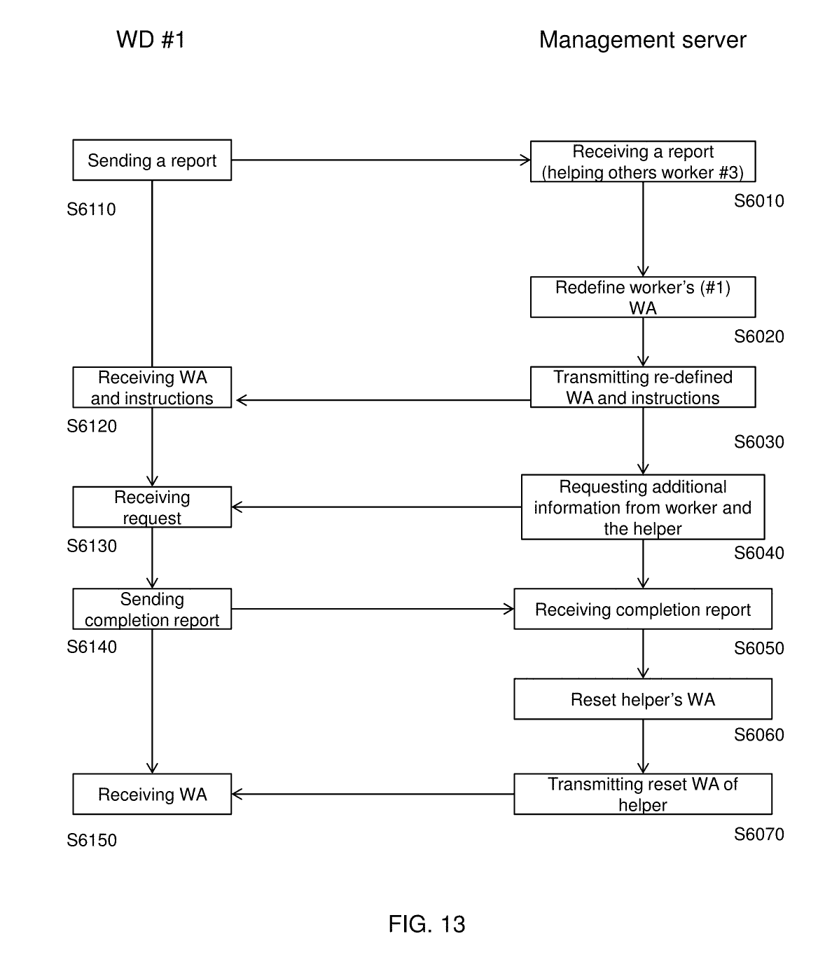

FIG. 13 is an exemplary flow chart illustrating operations for managing workers according to other embodiments of the present disclosure. In this scenario, a worker (e.g., #1) sends a report/request to the management server before the worker #1 moves outside the assigned work area.

The worker device #1 sends a report or a request to the management server notifying that the worker #1 will move outside the assigned work area to help another worker (e.g., worker #3) (S6110) and the management server receives the report/request (S6010). The request may include additional information, for example, the current location of the worker #1. The management server redefines the work area for the worker #1 to include the location of the worker #3 and/or the work area assigned to the worker #3 (S6020), so that even though the worker #1 works outside the originally assigned work area, the worker device #1 and/or the management server do not alert the worker.

The redefined work area is transmitted to the worker device of the worker #1, together with additional information (S6030), and the worker device of the worker #1 receives the redefined work areas and the additional information (S6120). The additional information to the worker #1 may include suitable instructions to resolve the issue with respect to the worker #3. After a predetermined time, the management server may transmit a request for additional information to the worker device to request the worker #1 current situation (S6040), and the worker device receives such a request (S6130).

When the worker #1 resolves the issue, the worker #1 sends a completion report to the management server (S6140), and the management server receives the completion reports (S6050). When the management server receives the completion report, the management server resets the redefined work area for the worker #1 to the original work areas (S6060), and the reset work area is transmitted from the management server to the worker device (S6070), and the worker device #1 receives the reset work areas (S6150). In some embodiments, the reset work area is transmitted, and in other embodiments, an instruction to reset the work area to the original work area is transmitted.

In certain embodiments, the management server redefines new work areas for the worker #1 and/or one or more other workers depending on the result of the worker #3's issue. For example, the new work areas may be redefined for the workers #1 and #2 to cover the work area of the worker #3, if worker #3 cannot continue working.

In the present disclosure, the system for tracking and managing locations of workers monitors workers' locations and determines whether they are working within the assigned work areas, respectively. If the system determines that a worker is outside of the assigned area by some reasonable or legitimate reasons, the system redefines the work areas of the worker and/or one or more additional workers. By redefining the work areas, it is possible to avoid continuously alerting the workers, and to more systematically and flexibly manage and control workers/employees and their work areas.

In the foregoing embodiments, one or more of the operations described with flow charts may be omitted, and one or more additional operations may be performed in the flow charts. Further, the order of the operations may be changeable. In addition, one or more features of one embodiment can be applied to or employed by other embodiments, and the detailed description thereof is omitted for simplicity. For example, the process flows illustrated by FIGS. 7, 9 and/or 11 may be initiated by the worker device regardless whether or not the process flows illustrated by FIGS. 4 and/or 5 are performed.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for implementing the works area management system/method. The software code is executable by the general-purpose computer that functions as the management server and/or that controls worker devices. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for works area management system/method in essentially the manner performed in the implementations discussed and illustrated herein.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method for tracking workers in an amusement park, the method comprising:
defining work areas for the workers, respectively, and storing the defined work areas in a work area database of a management server, the work areas including a first work area defined for a first worker;
transmitting the defined work areas to worker devices, respectively, the worker devices including a first worker device provided for the first worker;
determining whether or not a location of the first worker device is within the first work area defined for the first worker;
when it is determined that the location of the first worker device is outside of the first work area, prompting the first user to input or select a report, and when the report is acquired by the first worker device, wirelessly transmitting the report from the first worker device to the management server; and
determining an action in response to the transmitted report, and wirelessly transmitting assistance information corresponding to the determined action from the management server to one or more of the worker devices.

2. The method of claim 1, wherein the first worker device determines whether or not the location of the first worker device is within the first work area defined for the first worker.

3. The method of claim 1, wherein the management server determines whether or not the location of the first worker device is within the first work area defined for the first worker.

4. The method of claim 1, wherein:
the action includes finding at least one second worker located adjacent to the first work area,
the assistance information includes instructions for the second worker to help the first worker, and
the assistance information is wirelessly transmitted to a second worker device provided for the second worker.

5. The method of claim 4, wherein:
the action further includes redefining, by the management server, a second work area that has been defined for the second worker so as to include the location of the first worker device, and
the assistance information further includes the redefined second work area.

6. The method of claim 4, wherein:
one or more second workers are found,
the action further includes redefining, by the management server, one or more second work areas that have been defined for the one or more second workers so that the redefined one or more second work areas cover the first work area, and removing the first work area from the first worker,
the assistance information includes first assistance information to be sent to the first worker device including removal information of the first work area and second assistance information to be sent to one or more second worker devices including the redefined one or more second work areas, respectively.

7. The method of claim 4, wherein:
the action further includes determining, by the management server, a route from a location of the second worker device to the location of the first worker device, and
the assistance information further includes the determined route.

8. The method of claim 1, wherein, when the report is not acquired by the first worker device for a predetermined time duration, an alert message is wirelessly transmitted from the first worker device to the management server.

9. The method of claim 1, wherein the prompting the first user to input or select the report includes displaying on a display of the first worker device a list of response candidates.

10. A method for tracking workers in an amusement park, the method comprising:
defining work areas for the workers, respectively, the work areas including a first work area defined for a first worker;
wirelessly receiving, by a server, a communication from a first worker device assigned to and carried by the first worker;
based on the communication, finding a second worker located adjacent to the first work area, revising a second work area for the second worker and determining assistance information; and
wirelessly transmitting, by the server, the revised second work area and the assistance information to a second worker device assigned to and carried by the second worker.

11. The method of claim 10, wherein the assistance information includes instructions for the second worker to help the first worker.

12. The method of claim 10, wherein:
the revising the second work area includes revising the second work area so as to include a location of the first worker device, and
the assistance information further includes the location of the first worker device.

13. The method of claim 10, wherein:
one or more second workers are found,
the method further includes redefining, by the server, one or more second work areas that have been defined for the one or more second workers so that the redefined one or more second work areas cover the first work area, and removing the first work area from the first worker,
the assistance information includes first assistance information to be sent to the first worker device including removal information of the first work area and second assistance information to be sent to one or more second worker devices including the redefined one or more second work areas, respectively.

14. The method of claim 10, wherein:
the method further includes determining, by the server, a route from a location of the second worker device to a location of the first worker device, and
the assistance information further includes the determined route.

15. The method of claim 10, wherein:
the method further includes determining a response and wirelessly transmitting the response to the first worker device.

16. The method of claim 15, wherein the response include information with respect to the second worker.

17. A work area management system comprising:
a management server including a management-side computer and a management-side non-transitory storage medium storing a management program; and
a plurality of worker devices, including a first worker device assigned to a first worker, the first worker device including a device-side computer and a device-side non-transitory storage medium storing a device program, wherein:
the management program, when executed by the management-side computer, causes the management server to perform operations comprising:
defining a plurality of work areas for the plurality of workers, respectively;
storing the defined plurality of work areas in the management-side non-transitory storage medium, the plurality of work areas including a first work area defined for the first worker;
transmitting the defined plurality of work areas to the plurality of worker devices, respectively,
the device program, when executed by the device-side computer, causes the first worker device to perform operations comprising:
when it is determined, by the first worker device or the management server, that the location of the first worker device is outside of the first work area, prompting the first user to input or select a report, and when the report is acquired by the first worker device, wirelessly transmitting the report to the management server, and
the management program, when executed by the management-side computer, further causes the management server to perform operations comprising:
receiving the report from the first worker device;
determining an action in response to the report; and
wirelessly transmitting assistance information corresponding to the determined action to one or more of the plurality of worker devices.

18. The work area management system of claim 17, wherein:
the action includes finding at least one second worker located adjacent to the first work area,
the assistance information includes instructions for the second worker to help the first worker, and
the assistance information is wirelessly transmitted to a second worker device provided for the second worker.

19. The work area management system of claim 17, wherein:
the action further includes redefining, a second work area that has been defined for the second worker so as to include the location of the first worker device, and
the assistance information further includes the redefined second work area.

20. The work area management system of claim 17, wherein:
one or more second workers are found,
the action further includes redefining one or more second work areas that have been defined for the one or more second workers so that the redefined one or more second work areas cover the first work area, and removing the first work area from the first worker,
the assistance information includes first assistance information to be sent to the first worker device including removal information of the first work area and second assistance information to be sent to one or more second worker devices including the redefined one or more second work areas, respectively.
